(19) United States
(12) Patent Application Publication
(10) Pub. No.: US 2015/0246439 A1
(43) Pub. Date: Sep. 3, 2015

(54) DRYWALL MULTI-TOOL ASSEMBLY

(71) Applicant: Daniel J. Raymond, Saginaw, MI (US)

(72) Inventor: Daniel J. Raymond, Saginaw, MI (US)

(21) Appl. No.: 14/633,536

(22) Filed: Feb. 27, 2015

Related U.S. Application Data
(60) Provisional application No. 61/946,119, filed on Feb. 28, 2014.

(51) Int. Cl. B25F 1/02; E04F 21/165; B25B 15/00

(52) U.S. Cl. CPC B25F 1/02; B25B 15/00; E04F 21/1652

(57) ABSTRACT

One aspect of the present invention provides for a multi-tool assembly for use in drywall installation and repair. The multi-tool assembly includes a handle which extends in a first direction between opposite ends. A blade with a flat edge is secured with one end of the handle for spreading a drywall compound (also known as mud or putty) between adjacent drywall panels. A screwdriver bit is secured with an opposite end of the handle from the blade for fastening drywall panels. The screwdriver bit is disposed at an angle of between thirty and ninety degrees relative to the first direction to allow for increased torque on the screwdriver bit when fastening the drywall panels.

### CROSS-REFERENCE TO RELATED APPLICATIONS

This application claims the benefit of U.S. Provisional Application Ser. Nos. 61/946,119, filed Feb. 28, 2014, which is incorporated herein by reference in its entirety.

### BACKGROUND OF THE INVENTION

1. Field of the Invention

The present invention is related to hand-held multi-tool assemblies for use in drywall installation.

2. Related Art

Drywall installation typically first involves two or more panels to the studs in a building and then applying a drywall mud or putty to joints between the panels. This process usually requires intermittent use of a putty knife and a screwdriver. As such, many drywall workers carry two or more separate tools while on the job and are repeatedly switching between those tools since only one tool can be used at a time. This switching process can often be a time consuming and clumsy and may require the worker to take his or her eyes off of the project at hand.

### SUMMARY OF THE INVENTION AND ADVANTAGES

One aspect of the present invention provides for a multi-tool assembly for use in drywall installation and repair. The multi-tool assembly includes a handle which extends in a first direction between opposite ends. A blade with a flat edge is secured with one end of the handle for spreading a drywall compound (also known as mud or putty) between adjacent drywall panels. A screwdriver bit is secured with an opposite end of the handle from the blade for fastening drywall panels. The screwdriver bit is disposed at an angle of between thirty and ninety degrees relative to the first direction to allow for increased torque on the screwdriver bit when fastening the drywall panels.

The improved multi-tool assembly provides for significant improvements in efficiency because a user only has to use a single assembly for multiple operations and can switch between which operation he or she is performing by simply rotating that assembly and using the same handle for both fastening drywall pieces and spreading putty. Additionally, the thirty to ninety degree angle of the screwdriver bit relative to the extension of the handle allows a user to apply increased torque to the screwdriver bit.

Another aspect of the present invention is related to a method of installing or repairing drywall. The method includes the step of providing a multi-tool assembly which includes a single handle that extends in a first direction between opposite ends. The multi-tool assembly further includes a blade, which has a flat edge, that is secured with one of the ends of the handle and a screwdriver bit that is secured with the other end of the handle. The method continues with the step of screwing a screw with the screwdriver bit. The method proceeds with the steps of rotating the multi-tool assembly and spreading drywall putty with the flat blade.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a front elevation view of an exemplary embodiment of an improved multi-tool assembly;

FIG. 2 is an enlarged view of the multi-tool assembly of FIG. 1 and focused on a screwdriver bit;

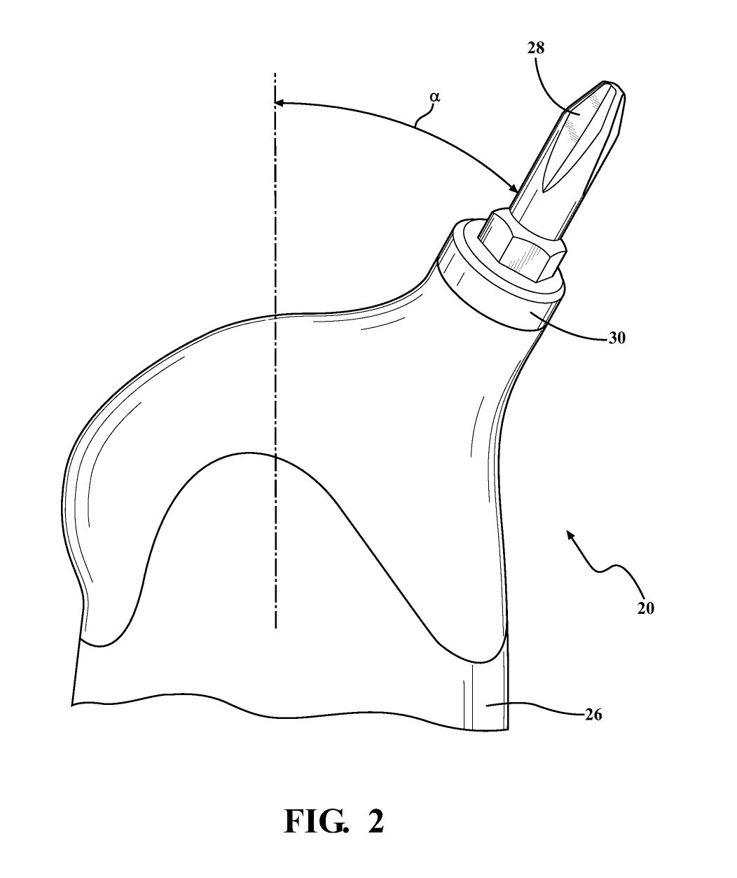

FIG. 3 shows the multi-tool assembly of FIG. 1 being used to fasten drywall; and

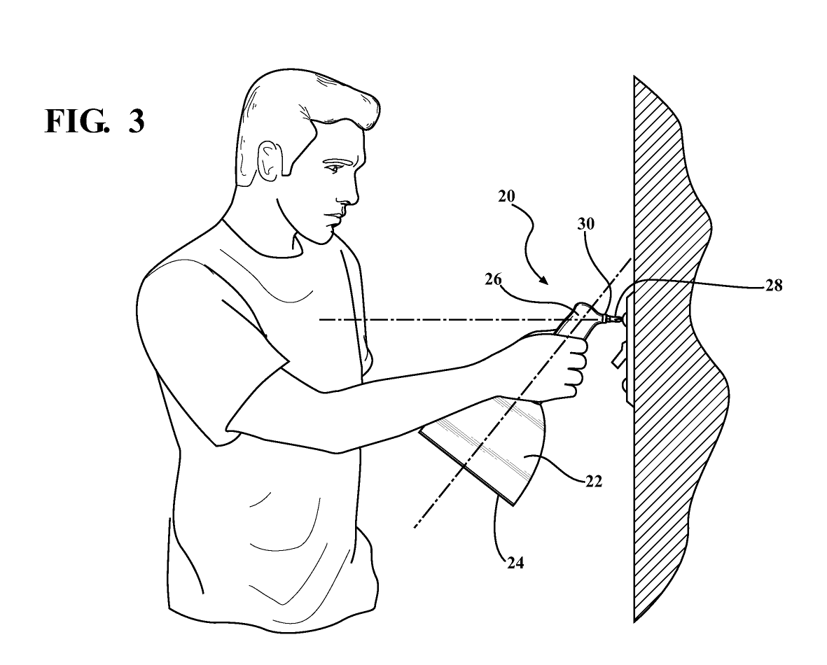

FIG. 4 shows the multi-tool assembly of FIG. 1 being used to spread putty.

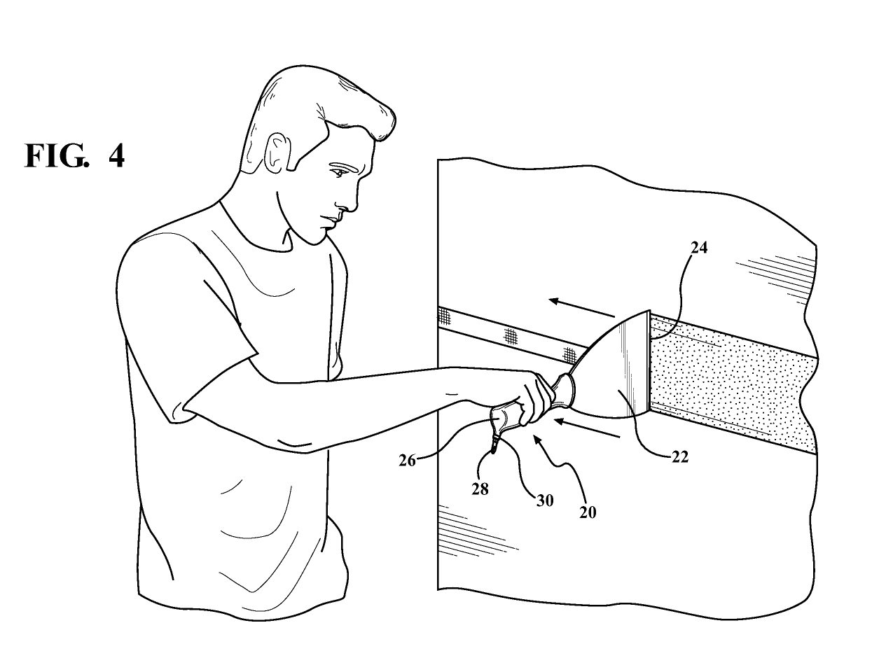

### DESCRIPTION OF THE ENABLING EMBODIMENT

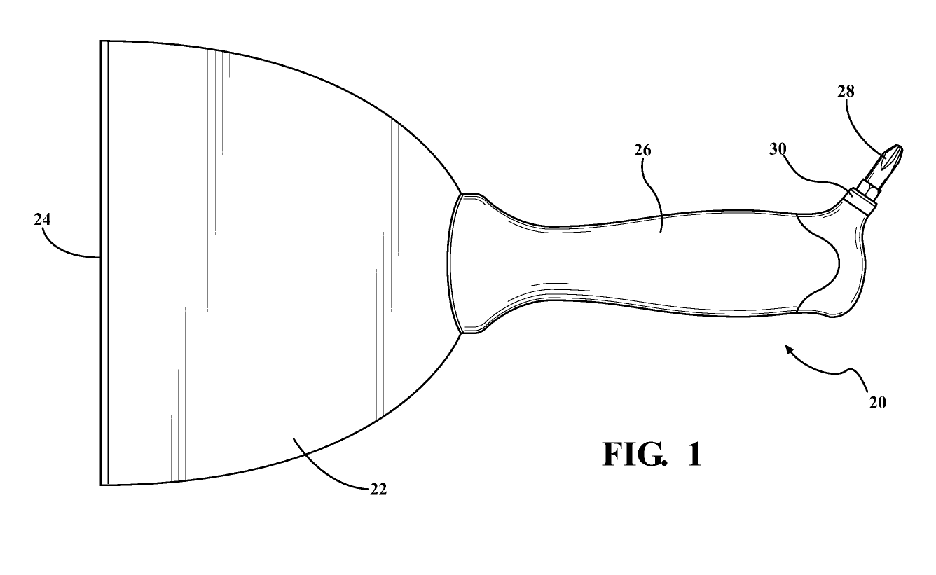

Referring to FIG. 1, wherein like numerals indicate corresponding parts throughout the several views, an exemplary embodiment of an improved drywall taping assembly 20 is generally shown in FIG. 1. As shown, the exemplary drywall knife assembly 20 includes a generally planar blade 22 with a flat edge 24 and a handle 26 which is joined with the blade 22 opposite of the flat edge 24. The blade 22 is preferably made of a metal (such as, for example, stainless steel) or a hard plastic and the flat edge 24 is adapted for evenly spreading drywall putty onto a joint between adjacent drywall panels. In the exemplary embodiment, the blade 22 curves inwardly from the flat edge 24 to the handle 26. The flat edge 24 may have any suitable length, for example, two to six inches.

The handle 26 extends in a first direction, which is generally perpendicular to the flat edge 24 from the blade 22 to a distal end. The handle 26 may be made of any suitable material including, for example, rubber, nylon, plastic or metal and may be joined to the blade 22 through any suitable process including, for example, overmolding or adhesives. The handle 26 may also be shaped with finger grooves, a texturing or other features for enabling improved gripping during use.

At the distal end of the handle 26 opposite of the blade 22, the exemplary assembly 20 includes a Phillips head screwdriver bit 28. As such, the single assembly 20 includes tools for both rotating screws to fasten drywall panels and for spreading a drywall putty between adjacent panels. These tools are located at opposite sides of the handle 26 from one another, and thus, the assembly 20 may be rotated switch between using the Phillips head screwdriver bit 28 to fasten drywall panels to using the flat edge 24 of the blade 22 to spread drywall putty.

The Phillips head screwdriver bit 28 may be joined to the handle 26 through any suitable means including, for example, adhesives, welding, material deformation, etc. In the exemplary the Phillips head screwdriver bit 28 extends at an angle a of approximately thirty to ninety degrees (30-90°) relative to the first direction. More preferably, the Phillips head screwdriver bit 28 extends at an angle α of approximately forty-five degrees (45°) angle relative to the direction of the extension of the handle 26. This angling the Phillips head screwdriver bit 28 relative to the handle 26 allows a user to apply additional torque onto the Phillips head screwdriver bit 28 through the handle 26 as compared to if the Phillips head screwdriver bit 28 instead extended parallel to the handle 26.

In the exemplary embodiment, a sleeve 30, or a bit holder, with hexagonally shaped bore is permanently secured with the handle 26, and the Phillips head screwdriver bit 28 is removably disposed in the sleeve 30. This allows for replacement of the Phillips head screwdriver bit 28 in response to wear or any suitable bit including, for example, a flat heat bit or a torx bit.

Another aspect of the present invention provides for a method of installing drywall. The method includes the step of providing a multi-tool assembly 20 which includes a single handle 26 which extends in a first direction between opposite ends and has a blade 22 with a flat edge 24 at one end and a screwdriver bit 28 at the other end. The method continues with the step of screwing a screw with the screwdriver bit 28 to fasten a drywall panel. The method continues with the steps of rotating the multi-tool assembly 20 and spreading drywall putty with the flat blade 22.

Obviously, many modifications and variations of the present invention are possible in light of the above teachings and may be practiced otherwise than as specifically described while within the scope of the appended claims.

What is claimed is:

1. A multi-tool assembly for use in drywall installation or repair comprising:
a handle which extends in a first direction between opposite ends;
a blade with a flat edge secured with one end of said handle for spreading drywall compound between adjacent drywall panels;
a screwdriver bit secured with an opposite end of said handle from said blade for fastening drywall panels; and
said screwdriver bit being disposed at an angle of between thirty and ninety degrees relative to said first direction to allow for increased torque on said screwdriver bit when fastening the drywall panels.

2. The multi-tool assembly as set forth in claim 1 wherein said screwdriver bit is a Phillips head screwdriver bit.

3. The multi-tool assembly as set forth in claim 1 wherein said screwdriver bit is disposed at approximately a forty-five degree angle relative to said first direction.

4. The multi-tool assembly as set forth in claim 1 further including a sleeve which is permanently secured with said handle and wherein said screwdriver bit is removably disposed in said sleeve.

5. A method of installing or repairing drywall, comprising the steps of:
providing a multi-tool assembly including a single handle which extends in a first direction between opposite ends and has a blade with a flat edge at one end and a screwdriver bit at the other end;
screwing a screw with the screwdriver bit;
rotating the multi-tool assembly; and
spreading drywall putty with the flat blade.

6. The method as set forth in claim 5 wherein the screwdriver bit is a Phillips head screwdriver bit.

7. The method as set forth in claim 5 wherein the screwdriver bit is disposed at an angle of thirty to ninety degrees relative to the first direction.

8. The method as set forth in claim 7 wherein the screwdriver bit is disposed at an angle of approximately forty-five degrees relative to the first direction.

9. The method as set forth in claim 5 wherein the multi-tool assembly further includes a sleeve which is permanently secured with the handle.

10. The method as set forth in claim 9 further including the step of removably securing the screwdriver bit with the sleeve.
